(19) United States
(12) Patent Application Publication
(10) Pub. No.: US 2026/0293861 A1
(43) Pub. Date: Oct. 1, 2026

(54) A CAGE SYSTEM AND A METHOD OF REARING FISH IN A SUBMERGED CAGE

(71) Applicant: Elska Seafood AS, Bønes (NO)

(72) Inventors: Vidar Saue, Bønes (NO); Örvar Gudni Arnarson, Vestmannaeyjar (IS)

(21) Appl. No.: 19/475,991

(22) PCT Filed: Apr. 23, 2024
(86) PCT No.: PCT/NO2024/050098

§ 371 Date: Oct. 16, 2025

(30) Foreign Application Priority Data
Apr. 26, 2023 (NO) 20230460

(51) Int. Cl. A01K 61/60

(52) U.S. Cl. CPC A01K 61/60

(57) ABSTRACT

A cage system comprising a cage (1) configured for being submerged in a body of water (W). An air module can be attached to the top of the cage (1) for providing a supply of air when the cage (1) is submerged in water, and one or more light sources (11) are arranged in the dome (42) and operated to emit light to attract fish and/or zooplankton into the cage and/or to simulate daylight. The invention provides a system by means of which zooplankton and mesopelagic fishes may be attracted to the underwater cage, as feed for the fish inside the cages. The invention removes the need for man-made feed and increases fish welfare because the fish is in deep waters and not near the water surface where waves are common. The invention will reduce the problem with fouling on the cage nets, will provide a stable water temperature inside the cage, ensure an oxygen-rich flow of water, with less parasites, jellyfish, virus and bacteria than in prior art cages.

WO

### TECHNICAL FIELD OF THE INVENTION

The invention concerns the field of aquaculture. More specifically, the invention concerns a cage system comprising a cage configured for being submerged in a body of water below a water surface, and a method of rearing fish in a cage submerged in a body of water.

### BACKGROUND OF THE INVENTION

Traditional fishfarming involves confining fish to net pens or cages floating in a body of water and feeding them specially manufactured, man-made, fish feed. Traditional fishfarming is associated with a number of undesirable consequences, such as poor fish welfare, local pollution, and the expenses and environmental impact of fish feed manufacturing. Other drawbacks of fishfarming in cages close to the water surface include fouling of nets, unstable water temperatures, water depleted of oxygen, parasites (like), jellyfish, and bacteria entering the cage. There is a need for a system that improves the existing technology, and in particular reduces the dependence on manufactured fish feed.

### SUMMARY OF THE INVENTION

The invention is set forth and characterized in the main claim, while the dependent claims describe other characteristics of the invention.

It is thus provided a cage system comprising a cage configured for being submerged in a body of water, characterized by an air module attached to the cage for providing a supply of air when the cage is submerged in water, the air module comprising a dome, an air reservoir and an air supply hose, and one or more light sources are arranged in the cage or dome and operable to emit light to attract fish and/or zooplankton into the cage and/or to simulate daylight.

In one embodiment, the cage further comprises a net and upper and lower support members and a plurality of intermediate members to hold the net in the desired shape; wherein a central module arranged in or on the cage and connected to power and control devices in or via a surface facility; and a primary cable is configured for supporting the cage in and above the body of water.

The plurality of light sources may be suspended inside the cage via a secondary cable, wherein the secondary cable is dimensioned for supporting the light sources and comprises cables and/or wires for controlling the light sources, transmitting electrical signals, and for supplying electrical power to the light sources.

The one or more light sources may comprise one or more light-emitting diodes (LED) and may be configured and controlled for emitting light in the range between 450 nm and 570 nm. However, other light sources and wavelength ranges are conceivable.

The primary cable may extend to the bottom of the cage and be connected to a lower support member or to the ballast element, and not connected to the upper support member, whereby when the primary cable is moved upwards, the cage is collapsed.

The cage system may further comprise a valve assembly arranged at the bottom of the cage, and the valve assembly may comprise a lower foundation having flange portion, and an axial member extending upwards from the lower foundation and connecting to a stopper member which is connected to the primary cable, wherein when the valve assembly is in a lower-closed position a lower cage opening is abutting against the flange portion, and when the primary cable is pulled upwards the cage opening is moved upwards until it abuts against the stopper member.

The central module may comprise a receptacle body and a slider, wherein the receptacle body is configured for connection to the top of the cage and comprises an upper opening, a cavity, and a bottom portion, and a primary passage centrally located in the bottom portion and at least one secondary passage are arranged in the bottom portion to provide access to the cage interior, wherein the slider comprises a body shaped and dimensioned to fit inside the cavity and comprises a primary channel arranged coaxially with a central axis of the slider and extending through the slider body, a slit parallel to and leading into the primary channel, a secondary channel arranged through the slider body and parallel with the primary channel; wherein the distance between the primary and secondary channels corresponds to the distance between the primary passage and at least one of the secondary passages.

The primary passage is preferably dimensioned to allow passage of the primary cable and the at least one secondary passage is dimensioned to allow passage of a secondary cable having a plurality of light sources.

The receptacle body may comprise a first alignment structure and the slider (52) may comprise a second alignment structure, whereby the first alignment structure and the second alignment structure have complementary shapes, such that the slider assumes a predetermined position when inserted into the receptacle body and the secondary channel becomes aligned with a secondary passage.

The cage system may further comprise a locking device located on the top or the bottom of the cage and comprising a rack housing and a pinion housing, wherein two pinion members are rotatably connected to the pinion housing, and two wedge-shaped rack members are connected to the rack housing, and each pinion member comprises a wheel member and a set of pinion gears on either side of the wheel member, wherein one or more electromagnets are arranged above the pinion housing, and one or more corresponding magnetic members are arranged on top of the pinion housing, and a guide wire rope runs through the locking device,
wherein when the cage is lifted and the at least one electromagnet is activated, the pinion housing is lifted whereby the cage is not attached to the guide wire rope and may be moved up or down along the guide wire rope, and;
wherein when the at least one electromagnet is deactivated, the pinion housing is released from the rack housing and is allowed to fall downwards such that the wedge-shaped rack member will force the two pinion members towards each other and cause the respective wheel member to bear against opposite sides of the guide wire rope and thus fixing the locking device against the guide wire rope.

In one embodiment, a guide wire rope extends from a module and the fish cage is movably connected to the guide wire rope such that it may move up and down in the water, controlled by buoyancy or other forces. In one embodiment, the guide wire rope extends below the cage and comprises a stopper for supporting a bottom region of the cage. In one embodiment, the guide wire rope is tethered to the seabed. In one embodiment, the cage system further comprises a valve assembly arranged at the bottom of the cage, and the valve assembly comprises a lower foundation having a support portion, and an axial member extending upwards from the lower foundation and connecting to a stopper member, wherein when the valve assembly is in a lower-closed position a lower cage opening is abutting against the flange portion, and when the cage is lifted the cage opening is moved upwards until it abuts against the stopper member. The lower foundation may comprise a collector device, configured for collecting and containing dead fish and waste from the cage. The collector device may comprise means for producing hypochloric acid and/or means for evacuating dead fish into a submergible container.

It is also provided a method of rearing fish in a cage submerged in a body of water, characterized by arranging and operating one or more light sources in the cage to emit light to attract zooplankton and/or fish into the cage and/or to simulate daylight.

One embodiment of the method comprises enclosing one or more fish in the cage, submerging the cage to a desirable depth in the body of water, and operating said one or more light sources to emit light to attract zooplankton and/or fish into the cage and/or to simulate daylight. In one embodiment, the cage is arranged in the body of water by a primary cable which extends from the cage and substantially to the surface, and the primary cable is fastened to a suitable foundation. In one embodiment, the cage is part of the cage system according to the invention.

The invention provides a system by means of which zooplankton and mesopelagic fishes may be attracted to the underwater cage, or a system of cages, as feed for the fish inside the cages. The invention removes the need for man-made feed and increases fish welfare because the fish is in deep waters and not near the water surface where waves are common. Natural feed will also increase the fish welfare. This invention will reduce the problem with fouling on the cage nets, will provide a stable water temperature inside the cage, ensure an oxygen-rich flow of water, with less parasites, jellyfish, virus and bacteria than in prior art cages.

Hence, the invented fish farming system is a more advantageous and efficient system than fish farming systems of the prior art. As the present invention is based on feeding the fish indigenous organism, and not man-made feed, the invented system may be referred to as a fish ranching system rather than a fish farming system.

The present invention overcomes the disadvantages and drawbacks of fish farming, and provides a ranching system and a method for ranching groundfish and redfish, such as cod and salmon, without using man-made feed.

The present invention relates to an underwater ranching system for groundfish and redfish which attracts zooplankton and mesopelagic fishes as a feed for the ranched fish. The system comprises an underwater cage system with one or more light sources. The light source may for example be configured and operated to emit light waves between 450 nm and 570 nm (blue/green).

### BRIEF DESCRIPTION OF THE DRAWINGS

These and other characteristics of the invention will become clear from the following description of embodiments of the invention, given as non-restrictive examples, with reference to the attached schematic drawings, wherein:

FIGS. 1a and 1b are illustrations of embodiments of the net cage according to the invention, installed in a body of water;

FIGS. 2a-c and 3 illustrate a retrieval procedure of the net cage according to the invention;

FIG. 4a illustrates a first embodiment of a valve assembly in a lower-closed position, and FIG. 4b illustrates the valve assembly in an upper-closed position;

FIG. 5a illustrates a second embodiment of a valve assembly in a lower-closed position, and FIG. 5b illustrates the valve assembly in an upper-closed position;

FIGS. 6a and 6b are perspective drawings with transparent views of a first embodiment of a central module, also referred to as an equipment-and-electronics valve;

FIGS. 7a and 7b are elevation transparent views of an installation sequence of the embodiment illustrated in FIGS. 6a and 6b,

FIG. 8 is a perspective view of an assembled state of the embodiment illustrated in FIGS. 6a, 6b, 7a, and 7b;

FIG. 9 is a perspective view of another embodiment of the central module;

FIGS. 10a-c illustrate an installation sequence of the embodiment illustrated in FIG. 9;

FIG. 11a, b and 12a-c illustrate other embodiments of the central module;

FIG. 13 a, b are perspective views of an embodiment of an air module attached to the top of a cage;

FIG. 14 illustrates various embodiments of fish traps;

FIG. 15a, b illustrate a hatch trap, in open and closed states;

FIGS. 16a-c are schematic illustrations of a guidewire system and an associated cage depth control sequence;

FIG. 17a is a perspective view of a locking device, FIG. 17b is a perspective view of a pinion member, and FIG. 17c is a perspective view of a rack member;

FIGS. 18a and 18b are perspective views of a rack housing and a pinion housing, respectively, of the locking device illustrated in FIG. 17a;

FIGS. 19 and 20 are side view sketches showing the locking device illustrated in FIG. 17a in an inactivated position and an activated position, respectively;

FIGS. 21 and 22 illustrate the locking device in relation to a cage member and a central member;

FIG. 23a illustrates a third embodiment of a valve assembly in a lower-closed position, and FIG. 23b is a section drawing of the valve assembly;

FIG. 24a illustrates the valve assembly illustrated in FIG. 23a in a lower-closed position, and FIG. 24b illustrates the valve assembly in an upper-closed position;

FIGS. 25a and 25b illustrate a collector device arranged around the valve assembly (FIG. 25b being a section drawing of FIG. 25a);

FIGS. 26a and 26b correspond to FIGS. 25a and 25b, and illustrates the valve assembly with the collector device, in an upper-closed position; and

FIG. 27 corresponds to FIGS. 25a and 25b, and illustrates an evacuation system connected to the collector device.

### DETAILED DESCRIPTION OF EMBODIMENTS OF THE INVENTION

The following description may use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings and that are associated with a normal use of the invention. The terms are used for the reader's convenience only and shall not be limiting.

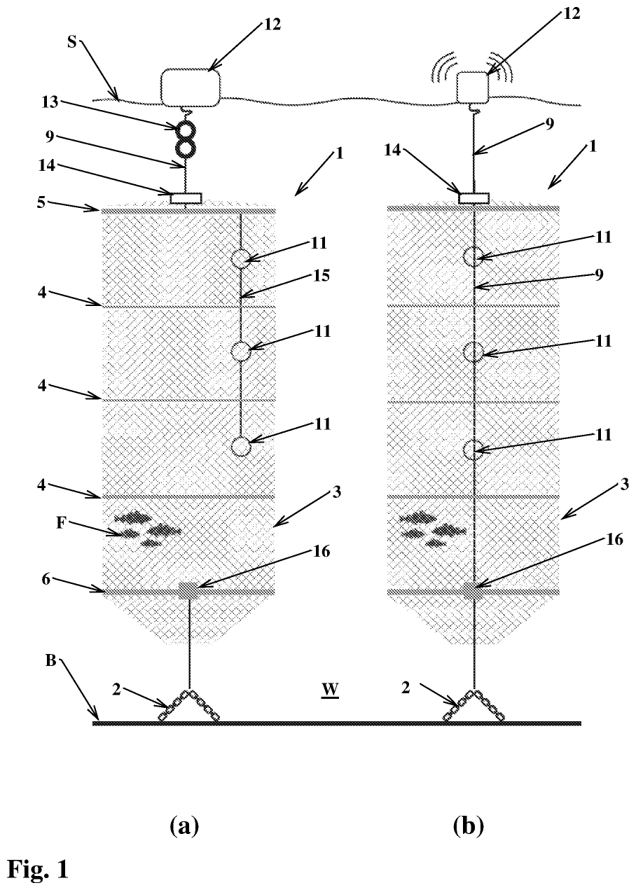

Referring initially to FIG. 1a, the invented cage system comprises in a first embodiment a cage 1 configured for being submerged in a body of water W. In the illustrated embodiment, the cage 1 is a net cage with a net 3 having a mesh width dimensioned for retaining the fish F to be farmed, but allowing smaller organisms, such as plankton, and particles to pass through. The cage 1 comprises an upper support member 5 and a lower support member 6. In the illustrated embodiment, the upper and lower support members 5, 6 are ring members. The upper support member 5 preferably has a positive or neutral buoyancy, and the lower support member 6 preferably has a neutral or negative buoyancy. A plurality of intermediate members 4, for example ring members, are arranged between the upper and lower support members 5, 6. The members 4-6 serve to hold the net 3 in the desired shape (e.g. cylindrical), in a manner well known in the art. The cage 1 may have the shape of a cylinder, an octagon, a cube, or a sphere.

The cage 1 is configured to be maintained at a desired depth in the water W below the water surface S. This may be accomplished by an appropriate dimensioning of the buoyancy in the upper and lower support members 5, 6, a ballast element 2, for example a steel chain or a clump weight, attached to the lower part of the cage, by suspending the cage to a surface facility 12, one or more buoyancy devices 13 arranged above the cage, or by a combination of these features. In the illustrated embodiment, the ballast element 2 is connected to the lower support member 6 via one or more connection units 16, and may be resting—partly or completely—on a seabed B.

A central module 14 is arranged at the top of the cage, and is connected to power and control devices (not shown) in or via the surface facility 12. The central module 14 is preferably connected to the upper support member 5, directly or indirectly. The central module 14 is structurally connected to—and may be suspended by—the surface facility 12 via a primary cable 9. The primary cable 9 may comprise a rope or/and a cable and is dimensioned such that it is capable of supporting the cage, in and above the water, and may additionally comprise cables, wires, and/or conduits for controlling systems in the cage, transmitting electrical signals, and for supplying electrical power to the cage. The surface facility 12 may comprise a buoy or a platform and be moored to the seabed in a manner known in the art. Although not illustrated, it shall be understood that the cage may be furnished with sensors, cameras and other monitoring and control devices, as are known in the art.

In the embodiment illustrated in FIG. 1a, a plurality of light sources 11 are suspended from the upper support member 5 via a secondary cable 15. The secondary cable 15 is dimensioned such that it is capable of supporting the light sources 11, and comprises cables and/or wires for controlling the light sources, transmitting electrical signals, and for supplying electrical power to the light sources. The light sources preferably comprise one or more light-emitting diodes (LED) and emit light in the range between 450 nm and 570 nm, but the invention is not limited to such light sources and wavelengths.

The embodiment of the cage illustrated in FIG. 1b comprises the same features as the embodiment of the cage illustrated in FIG. 1a, but in the cage in FIG. 1b, the primary cable 9 extend to the bottom of the cage. Here, the primary cable 9 may be connected to the lower support member 6 or to the ballast element 2. In the embodiment illustrated in FIG. 1b, the primary cable 9 is not connected to the upper support member 5.

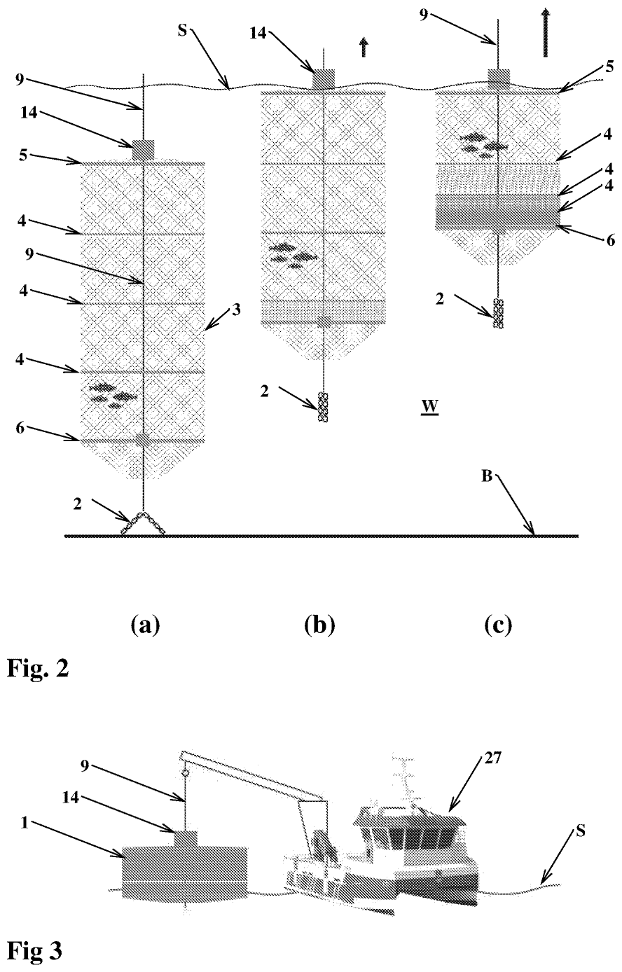

Therefore, when the primary cable 9 is moved upwards, the cage 1 is compressed (collapsed) as illustrated in FIGS. 2a-c. This feature is useful for crowding fish inside the cage, bringing the fish closer to the surface as the cage is lifted upwards. When the cage has been emptied, the cage may be lifted above water (e.g. by a boat 27) in a very compact configuration, as illustrated in FIG. 3.

In the embodiment illustrated in FIG. 1b, the light sources 11 are centrally arranged inside the cage 1. Therefore, in this embodiment, the secondary cable 15 shown in FIG. 1a is not required, as the light sources 11 are suspended, powered, and controlled via the primary cable 9. Although not illustrated in FIG. 1b, it should be understood that the light sources may be suspended, powered, and controlled via a secondary cable running alongside the primary cable 9.

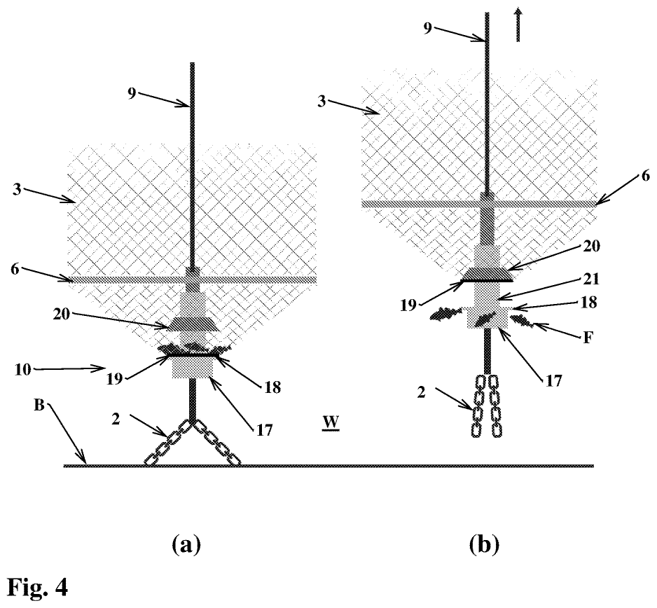

Referring now to FIG. 4a, b, the cage 1 comprises a valve assembly 10 at the cage bottom. FIG. 4a illustrates the valve assembly 10 in a lower-closed position, and FIG. 4b illustrates the valve assembly 10 in an upper-closed position. In the illustrated embodiment, the valve assembly 10 comprises a lower foundation 17 having flange portion 18. The ballast element 2 is connected to the lower foundation 17. The lower foundation 17 comprises buoyancy to support its portion of the cage weight, but when lifted the weight pulls it down. An axial member 21 extends upwards from the lower foundation 17 and connects to a stopper member 20. The stopper member 20 is connected to the primary cable 9. When the valve assembly 10 is in the lower-closed position (FIG. 4a), the lower cage opening 19 is abutting against the flange portion 18 and maintains the cage in a closed state. When the primary cable 9 is pulled upwards, as indicated in FIG. 4b, the cage structure, including the cage opening 19 is moved upwards until it abuts against the stopper member 20. A further upward movement of the primary cable 9 will cause the entire cage to be lifted upwards, as described above with reference to FIGS. 2a-c and 3. The purpose of the valve assembly 10 is to discard dead fish and other matter that has accumulated at the cage bottom. In the transition between the lower-closed position (FIG. 4a) and the upper-closed position (4b), such matter will fall out through the cage opening 19 by gravity.

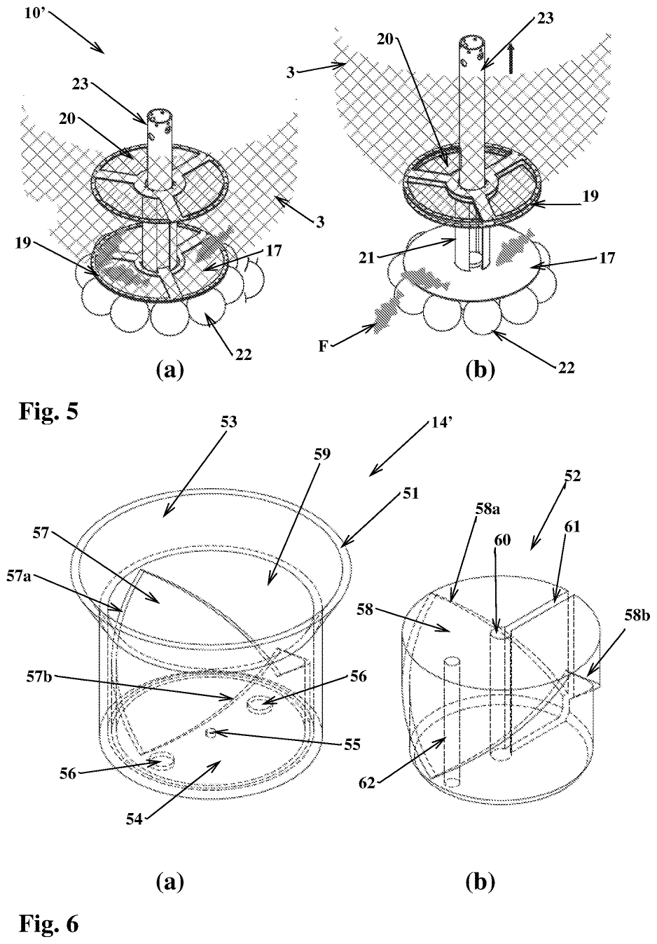

FIG. 5a, b illustrate an embodiment of the valve assembly discussed above with reference to FIG. 4a, b. FIG. 5a illustrates the valve assembly 10′ in a lower-closed position, and FIG. 5b illustrates the valve assembly 10′ in an upper-closed position. Reference number 22 denotes one or more buoyant member connected to the lower foundation 17, and reference number 23 denotes a stem extending upwards from the stopper member 20 and to which the primary cable 9 (not shown in FIG. 5a, b) may be connected. The valve assembly 10; 10′ may be made of plastic or metal.

An embodiment of the above-mentioned central module will now be described with reference to FIG. 6 a, b, 7a, b, and 8.

Referring initially to FIG. 6 a, b, the central module 14′ comprises in this embodiment a receptacle body 51 and a slider 52. It should be noted that any ancillary parts and devices (electrical cables, etc.) of the central module are not illustrated. The receptacle body 51 (FIG. 6a) is configured for connection to the top of the cage (the cage is not illustrated in FIG. 6a, b, 7a, b, and 8). The receptacle body 51 comprises an upper opening 53, preferably funnel-shaped, a cavity 59 and a bottom portion 54. A primary passage 55, centrally located in the bottom portion, and at least one (preferably two) secondary passage 56 are arranged in the bottom portion 54, each providing access to the cage interior. The primary passage 55 is dimensioned to allow passage of the primary cable 9. The secondary passage(s) 56 is dimensioned to allow passage of the secondary cable 15 with light sources 11, as well as a camera-and-sensor module 24. In the case of two secondary passages 56, the secondary passages are arranged diametrically opposite of each other, as illustrated in FIG. 6a. The receptacle body interior, i.e. inside the cavity 59, comprises a first alignment structure 57, in the illustrated embodiment comprising two oppositely arranged sloped ridge portions 57a, b projecting from the receptacle body interior wall.

Referring to FIG. 6b, the slider 52 comprises a body shaped and dimensioned to fit inside the cavity 59. In the illustrated embodiment, the slider body is cylindrical. A primary channel 60 is arranged coaxially with a central axis of the slider and extends through the slider body. The primary channel 60 is accessible in its entire length from outside the slider body via a slit 61, parallel to the primary channel. A secondary channel 62 is arranged through the slider body and is parallel with the primary channel. The distance between the primary and secondary channels 60, 62 corresponds to the distance between the primary passage 55 and at least one of the secondary passages 56.

The slider 52 comprises a second alignment structure 58, in the illustrated embodiment comprising two oppositely arranged sloped ridge portions 58a, b projecting from the slider body exterior wall. The first alignment structure 57 and the second alignment structure 58 have complementary shapes, such that the slider 52 assumes a predetermined position when inserted into the cavity 59 in the receptacle body 51.

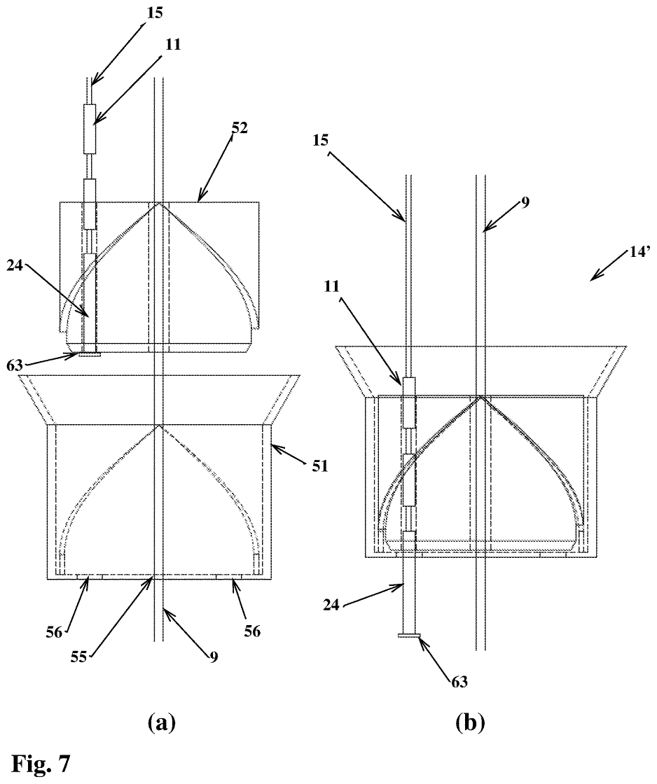

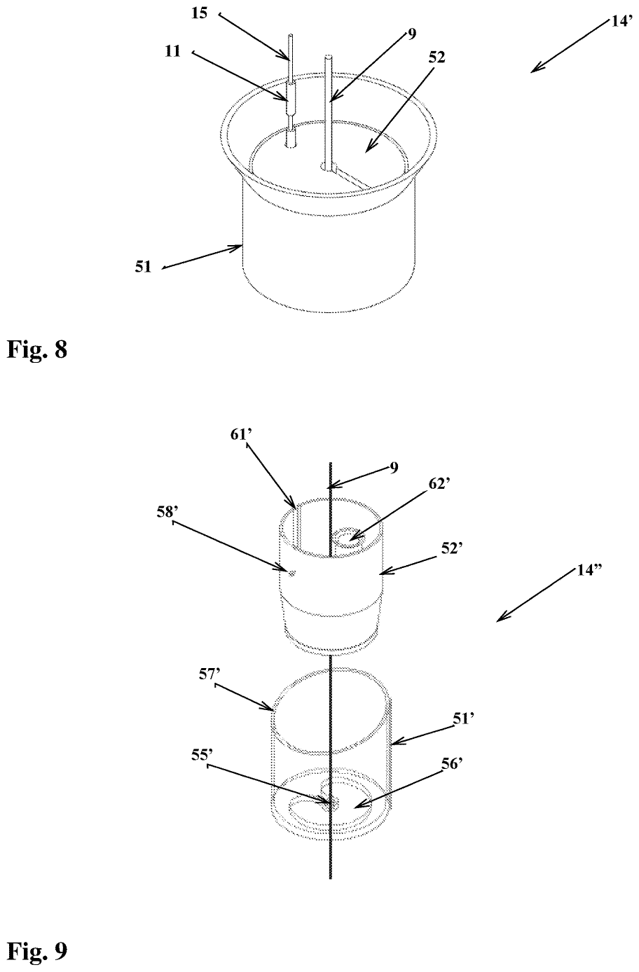

When the slider 52 is inserted into the receptacle body 51, the first and second alignment structures 57, 58 will cause the slider 52 to rotate, such that the secondary channel 62 becomes aligned with one of the secondary passages 56. This sequence is illustrated in FIG. 7 a, b and 8.

This embodiment of the central module 14′ may be used for installing equipment and electronics components inside the cage, and may therefore be referred to as an equipment-and-electronics valve (EEV). The receptacle body 51 is connected to the top of the cage and the primary cable 9 can run freely through the primary passage 55. The equipment and electronics components that are to be inserted into the cage are connected to the slider 52. Referring to FIG. 7a, the slider is suspended by the secondary cable 15, and this cable comprises light source units 11 and a camera-and-sensor module 24, as described above. In the illustrated embodiment, the slider suspension is achieved by a flange 63 on the camera-and-sensor module 24. This flange 63 is larger than the diameter of the secondary channel 62, and therefore carries the slider. Prior to installation, the primary cable 9 is introduced into the primary channel 60 through the slit 61, and the primary cable guides the slider towards the receptacle body. When the slider 52 enters the cavity 59, the first and second alignment structures 57, 58 will cause the slider to rotate such that the secondary channel 62 becomes aligned with one of the secondary passages 56, and the secondary cable 15 (with light source units 11 and camera-and-sensor module 24) may pass through the secondary passage 56 and lowered into the cage. It will be understood that the flange 63 is smaller than the diameter of the secondary passage 56. The first and second passages may be furnished with bristles or other pliant barriers, in order to prevent fish from escaping through the passages.

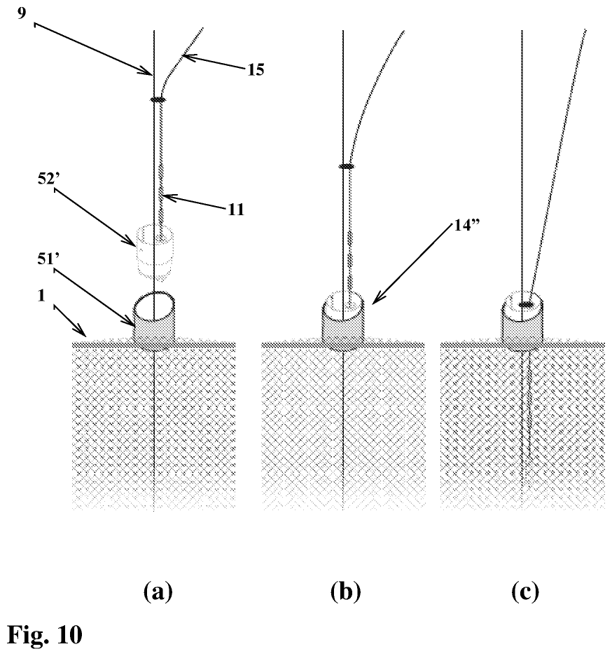

FIGS. 9 and 10a-c illustrate another version of the equipment-and-electronics valve (EEV) 14″. The receptacle body 51′ is configured for connection to the top of the cage (not illustrated). As in the embodiment described above, the receptacle body 51′ comprises an upper opening, a cavity and a bottom portion. A primary passage 55′, centrally located in the bottom portion, and a secondary passage 56′ are arranged in the bottom portion, each providing access to the cage interior. The primary passage 55′ is dimensioned to allow passage of the primary cable 9. The secondary passage 56′ allows passage of the secondary cable 15 with light sources 11, as well as a camera-and-sensor module 24. The receptacle body 51′ comprises a first alignment structure 57′ in the shape on an oblique circumferential edge 57′.

The slider 52′ comprises a body shaped and dimensioned to fit inside the receptacle body 51′ cavity. The cavity is accessible from outside the slider body via a slit 61′. A secondary channel 62 is arranged inside the cavity.

The slider 52′ comprises a second alignment structure 58′, in the illustrated embodiment comprising an element protruding from the slider exterior wall. When the slider 52′ is inserted into the receptacle body 51′, the first and second alignment structures 57′, 58′ will cause the slider 52′ to rotate, such that the secondary channel 62′ becomes aligned with the secondary passage 56′. This embodiment of the central module 14″ may be used for installing equipment and electronics components inside the cage, as described above. The FIGS. 10a-c illustrate an installation sequence, where the slider is suspended as described above. The first and second passages may be furnished with bristles or other pliant barriers, in order to prevent fish from escaping through the passages.

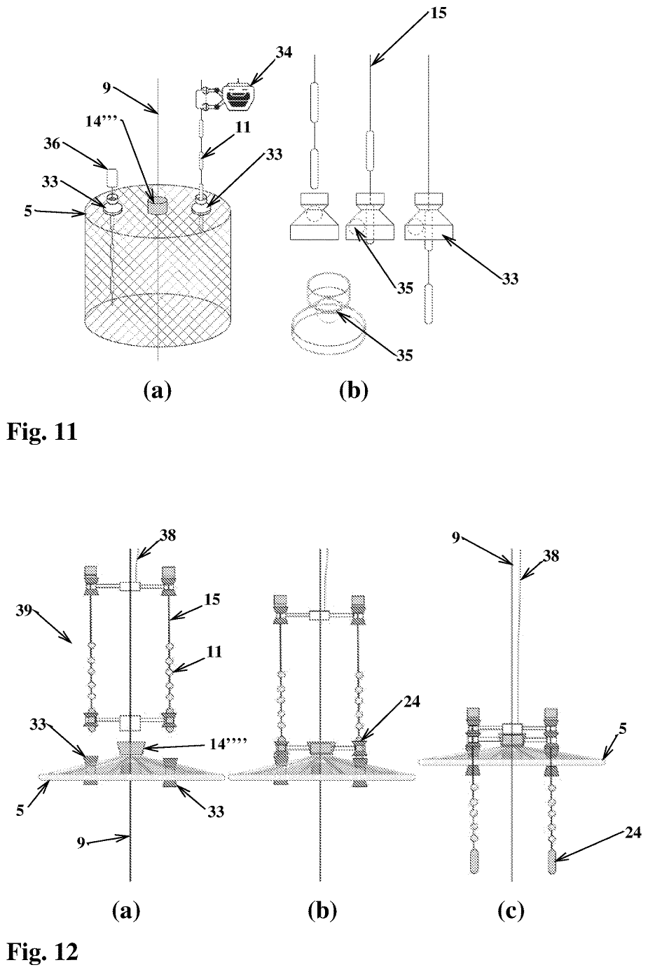

FIGS. 11a, b illustrate an embodiment of the central module. Here, the primary cable extends through the central module 14′″, and peripheral access modules 33 are arranged a distance from the central module. The secondary cable 15, including the light sources 11 and (optionally, not shown in FIGS. 11a-c) camera-and-sensor module extends through the access modules 33 and into the cage. FIG. 11a illustrates how a secondary cable is suspended by a salt water battery 36, and also how the secondary cable may be installed by a remotely operated vehicle (ROV) 34. FIG. 11b illustrates how a passage for the secondary cable 15 in the peripheral access module 33 may be the blocked by a buoyant sphere 35 when not in use. A set of bristles may also be used for the same purpose, as mentioned above.

FIGS. 12a-c illustrate yet another embodiment of the central module 14″″ also comprising an installation tool 39 by means of which the secondary cable(s) 15 are suspended and lowered into respective peripheral access modules 33. Reference number 38 denotes a power-and-control umbilical.

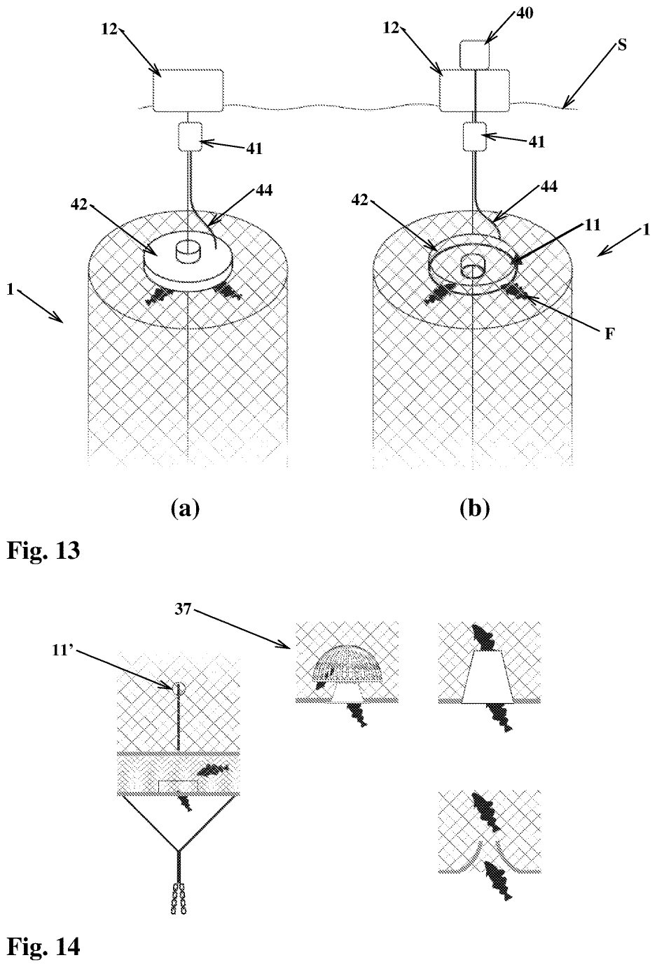

FIG. 13a, b are perspective views of an embodiment of an air module that can be attached to the top of a cage 1 and provide a supply of air when the cage is submerged in water. FIG. 13a illustrates the module as seen from above, and FIG. 13b as seen from below. The module comprises a dome 42 connected to the top of the cage 1, an air reservoir 41, and an air supply hose 44. The air reservoir 41 may be connected to an air pump 40 above the water surface. Light sources 11 (as described above) may be installed inside the dome 42 and operated to emit light that will attract fish F inside the cage and/or to simulate daylight. The dome 42 is configured to hold air. The light sources advantageously comprise LED lights that can emit light that mimics natural light and blue/green (light 450-570 nm), and facilitates artificial daylight simulation with dimmed light that simulate daylight and follows naturally light at sea surface. The light control may be based on sensor inputs. Such artificial daylight simulation may delay maturation in the fish and prolong the growth period. At night time, the light sources may be controlled to emit blue/green light to attract feed.

Although not illustrated, the invented cage system may include one or more sound transmitters that are controllable to emit pressure waves into the water. The emitted waves can be configured to attract certain species of fish and to repel others.

FIG. 14 illustrates various embodiments of fish traps. One or more fish traps 37 are located at the bottom of the cage 1, in order to catch wild cod or fingerlings to be ranched further in the cages. One or more light sources 11′ may be arranged inside the cage, as described above, to attract fish such as wild cod.

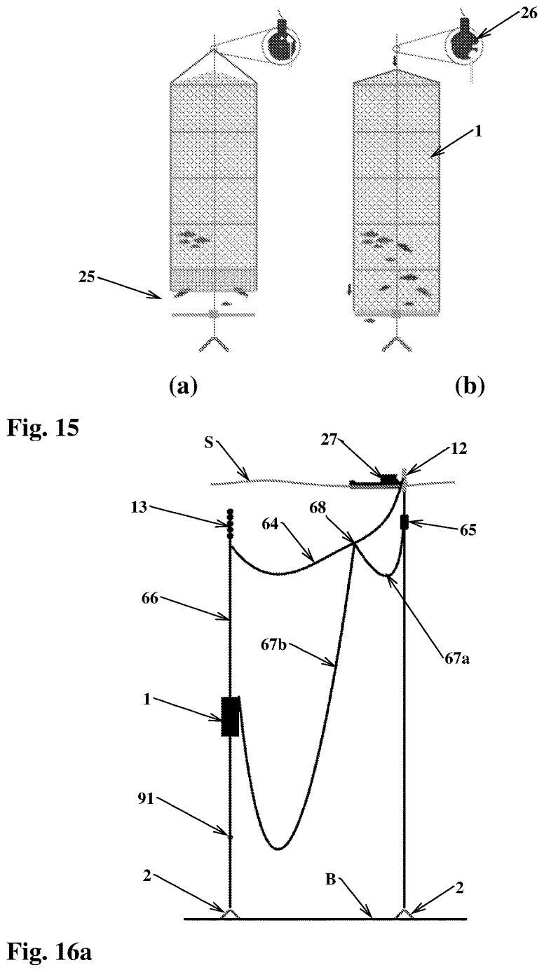

A fish trap may also comprise a hatch trap 25, as illustrated in FIG. 15a (open) and 15b (closed). The fish will swim freely into the cage, for example following zooplankton that has been attracted by the light sources inside the cage. When a desired number of fish has been trapped inside the cage (e.g. as monitored from camera or using other methods) a releasable hook 26 is activated, for example via an electromagnet device, to close the hatch.

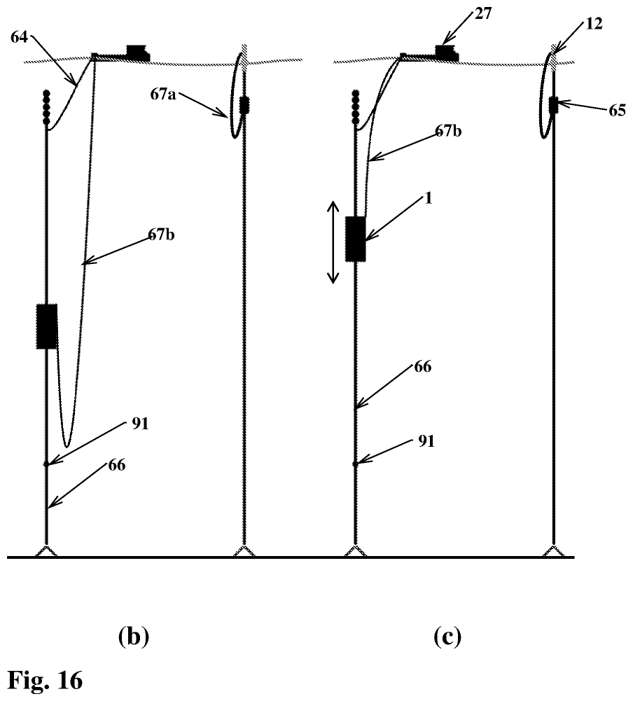

FIGS. 16a-c are schematic illustrations of a guidewire system and an associated cage installation sequence. A system module 65 is submerged in the water, tethered to the seabed via a ballast element 2, and connected to a surface buoy 12. A guide wire rope 14 66 is tethered to the seabed via a ballast element 2 a lateral distance away from the system module 65, and maintained taut by one or more buoyancy devices 13. A fish cage 1 is movably connected to the guide wire rope 66, and may move up and down in the water, as indicated by the double arrow in FIG. 16c.

In FIG. 16a, a mooring rope 64 connects the guide wire rope 66 to the surface buoy (communications buoy) 12. A first electricity and communication cable 67a extends between the system module 65 and a connector 68 on the mooring rope 64, and a second electricity and communication cable 67b extends between the connector 68 and the cage 1.

In FIG. 16b, the second electricity and communication cable 67b has been disconnected from the connector 68 and is attached to a ship 27, and the first electricity and communication cable 67a has been connected to the surface buoy 12. The mooring rope 64 has also been connected to the ship 27, and is reeled in as the ship approaches the buoyancy devices 13. FIG. 16c illustrates how the cage 1 may be moved up and down along the guide wire rope 66 by adjusting the length of the second electricity and communication cable 67b. The cage may thus be placed at a desired water depth.

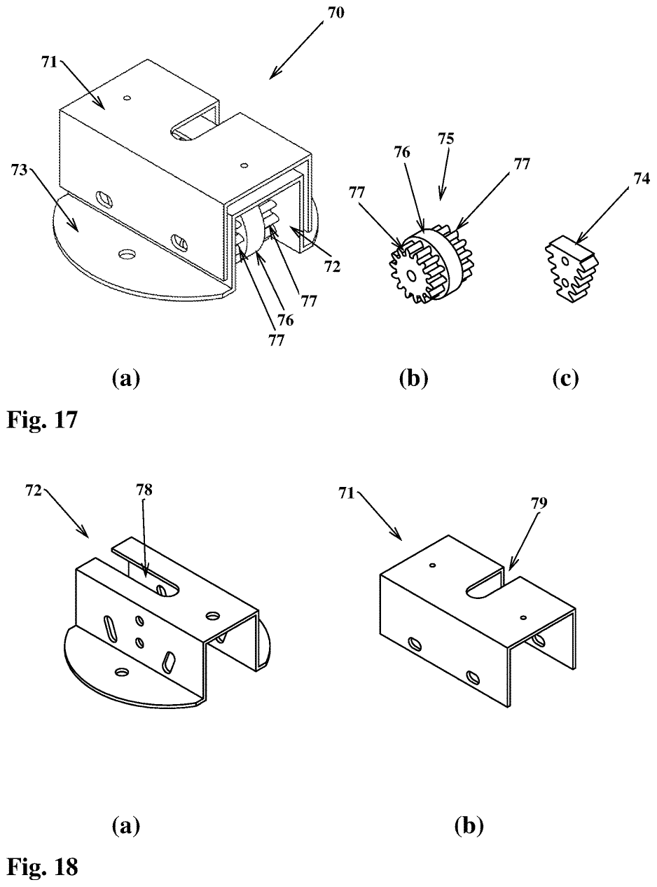

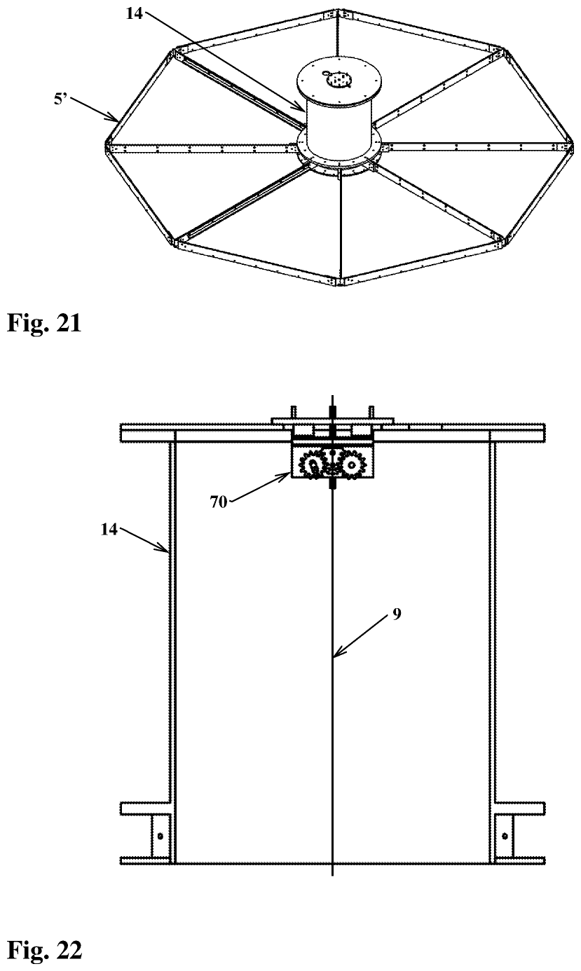

A locking device 70 will now be described with reference to FIGS. 17-22. The locking device 70 comprises a rack housing 72 and a pinion housing 71. The locking device 70 is located on the top of the cage, as illustrated in FIGS. 21 and 22. Two pinion members 75 are rotatably connected to the pinion housing 71, and two wedge-shaped rack members 74 are connected to the rack housing 72. Each pinion member 75 comprises a wheel member 76 and a set of pinion gears 77 on either side of the wheel member.

One or more electromagnets 81 are arranged above the pinion housing, and one or more corresponding magnetic members 80 are arranged on top of the pinion housing. The guide wire rope 66 runs through the locking device 70, in slits 78, 79.

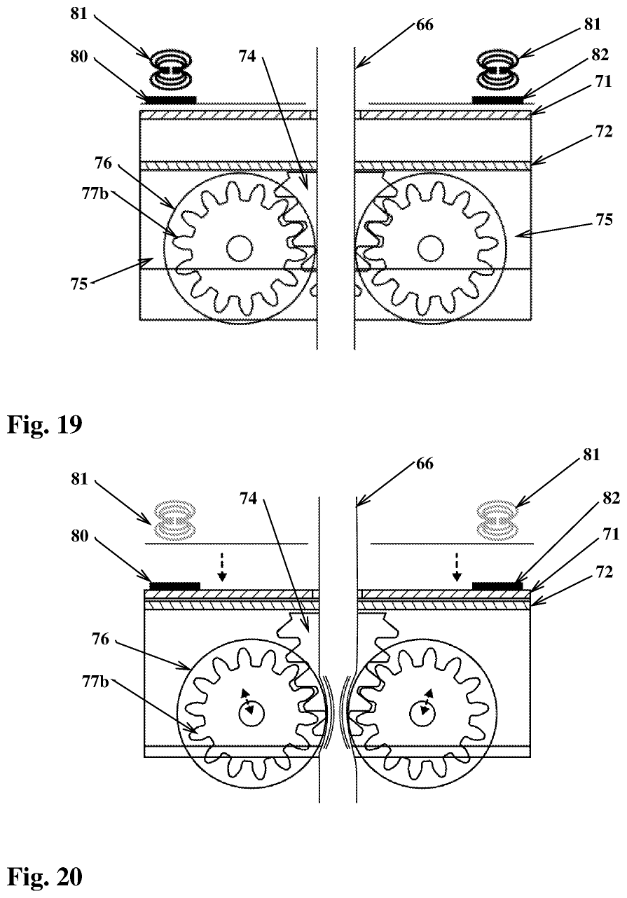

When the cage is lifted, as it is not locked for lifting, and at least one electromagnet 81 is activated, the pinion housing 71, including the pinion member 75, is lifted. In this state, the cage is not attached to the guide wire rope 66 and may be moved (up or down), for example by means of the electricity and communication cable mentioned above. This is illustrated in FIG. 19. The wheel member 76 may be made of steel, hard plastic or rubber.

When the at least one electromagnet 81 is deactivated, the pinion housing will fall down and the wedge-shaped rack member 74 will force the two pinion members 75 towards each other and cause the respective wheel member 76 to bear against opposite sides of the guide wire rope 66, thus fixing the locking device 70 against the guide wire rope 66. This is illustrated in FIG. 20.

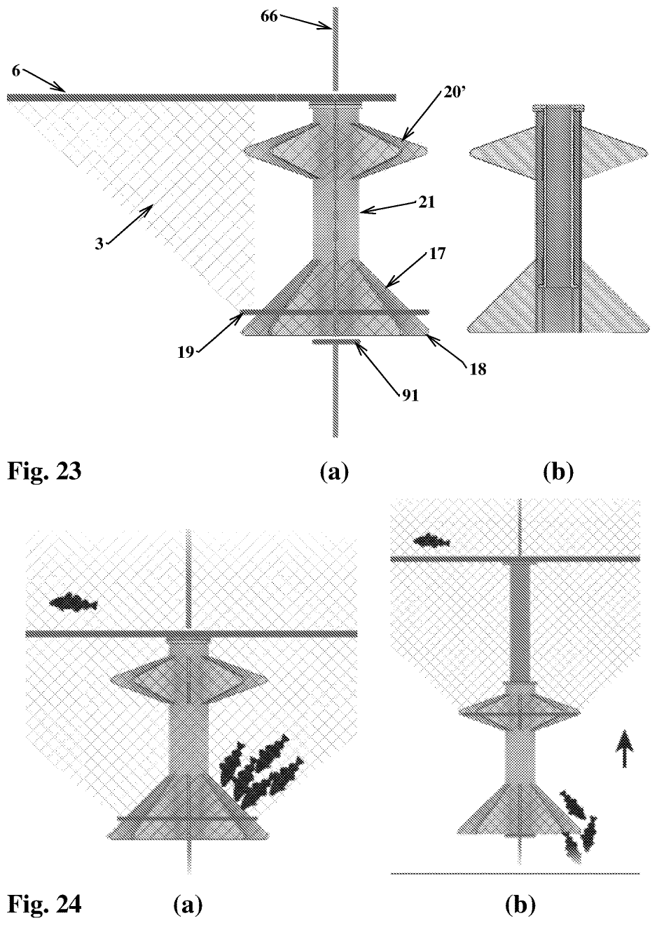

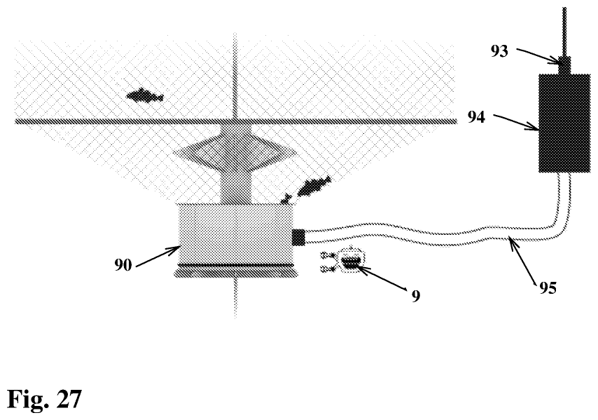

FIGS. 23-27 illustrate yet another embodiment of a valve assembly 10″ arranged at the cage bottom. This embodiment of the valve assembly 10″ comprises a lower foundation 17 having flange portion 18. The valve assembly 10″ is supported on a stopper support 91 which is connected to (and supported by) the guide wire rope 66 (see also stopper 91 in FIGS. 16a-c). An axial member 21 extends upwards from the lower foundation 17 and connects to a stopper member 20′, and the guide wire rope 66 extends through the axial member 21. When the valve assembly 10″ is in the lower-closed position (FIG. 24a), the lower cage opening 19 is abutting against the flange portion 18 and maintains the cage in a closed state. When the cage is lifted (for example as described above with reference to FIGS. 16a-c and as indicated in FIG. 24b, the cage structure, including the cage opening 19 is moved upwards until it abuts against the stopper member 20. The purpose of the valve assembly 10″ is to discard dead fish and other matter that has accumulated at the cage bottom. In the transition between the lower-closed position (FIG. 24a) and the upper-closed position (FIG. 24b), such matter will fall out through the cage opening 19 by gravity.

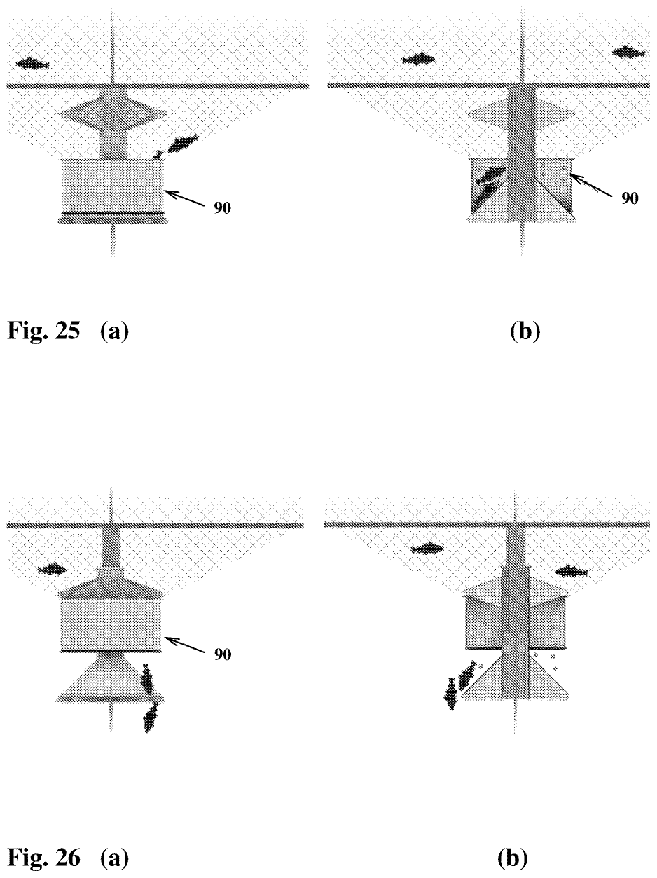

An alternative, illustrated in FIG. 25a, and 25b, comprises a collector device 90 arranged on the lower foundation 17, the purpose of which being to collect and contain dead fish and waste from the cage. In one embodiment the collector device 90 comprises means for producing hypochloric acid, for example as described in WO 2018/062999 A1.

In one embodiment, a container 94 comprising a pump 93 and a hose 95, is configured to being lowered into the water and connected to the collector device 90, for example by means of an ROV 9, whereby dead fish and waste may be pumped into the container 94. The container 94 may subsequently be retrieved to the water surface.

The cage system according to the invention comprises a self-supported habitat for fish, without a need for supplying man-made fish feed. After enclosing fish in the cage 1, the cage is submerged and arranged at a desired water depth by means of the devices described above. The dome 42 and associated air supply system provides air for the fish, and the light sources 11 are operable to attract feed, as described above.

1. A cage system comprising:
a cage configured for being submerged in a body of water,
an air module attached to the cage for providing a supply of air when the cage is submerged in water, the air module comprising a dome,
an air reservoir and an air supply hose, and
one or more light sources arranged in the cage or dome and operable to emit light to attract fish and/or zooplankton into the cage and/or to simulate daylight.

2. The cage system of claim 1, the cage further comprising a net and upper and lower support members and a plurality of intermediate members to hold the net in the desired shape; wherein:
a central module arranged in or on the cage and connected to power and control devices in or via a surface facility; and
a primary cable configured for supporting the cage in and above the body of water.

3. The cage system of claim 2, wherein a plurality of light sources are suspended inside the cage via a secondary cable, wherein the secondary cable is dimensioned for supporting the light sources and comprises cables and/or wires for controlling the light sources, for transmitting electrical signals, and for supplying electrical power to the light sources.

4. The cage system of claim 1, wherein the one or more light sources comprise one or more light-emitting diodes (LED) and are configured and controlled for emitting light in the range between 450 nm and 570 nm.

5. The cage system of claim 2, wherein the primary cable extends to the bottom of the cage and is connected to a lower support member or to the ballast element, and is not connected to the upper support member, whereby when the primary cable is moved upwards, the cage is collapsed.

6. The cage system of claim 1, further comprising a valve assembly arranged at the bottom of the cage, the valve assembly comprises a lower foundation having a support portion, and an axial member extending upwards from the lower foundation and connecting to a stopper member which is connected to the primary cable, wherein when the valve assembly is in a lower-closed position, a lower cage opening is abutting against the flange portion, and when the primary cable is pulled upwards, the cage opening is moved upwards until it abuts against the stopper member.

7. The cage system of claim 2, wherein:
the central module comprises a receptacle body and a slider, wherein the receptacle body is configured for connection to the top of the cage and comprises an upper opening, a cavity, and a bottom portion, and a primary passage centrally located in the bottom portion and at least one secondary passage are arranged in the bottom portion to provide access to the cage interior, and
the slider comprises:
a body shaped and dimensioned to fit inside the cavity and comprises a primary channel arranged coaxially with a central axis of the slider and extending through the slider body,
a slit parallel to and leading into the primary channel, and
a secondary channel arranged through the slider body and parallel with the primary channel;
wherein the distance between the primary and secondary channels corresponds to the distance between the primary passage and at least one of the secondary passages.

8. The cage system of claim 7, wherein the primary passage is dimensioned to allow passage of the primary cable and the at least one secondary passage is dimensioned to allow passage of a secondary cable having a plurality of light sources.

9. The cage system of claim 7, wherein the receptacle body comprises a first alignment structure and the slider comprises a second alignment structure, whereby the first alignment structure and the second alignment structure have complementary shapes, such that the slider assumes a predetermined position when inserted into the receptacle body and the secondary channel becomes aligned with a secondary passage.

10. The cage system of claim 1, further comprising a locking device located on the top or the bottom of the cage and comprising a rack housing and a pinion housing, wherein two pinion members are rotatably connected to the pinion housing, and two wedge-shaped rack members are connected to the rack housing, and each pinion member comprises a wheel member and a set of pinion gears on either side of the wheel member, wherein one or more electromagnets are arranged above the pinion housing, and one or more corresponding magnetic members are arranged on top of the pinion housing, and a guide wire rope runs through the locking device, wherein when the cage is lifted and at least one electromagnet is activated, the pinion housing is lifted whereby the cage is not attached to the guide wire rope and may be moved up or down along the guide wire rope, and wherein when the at least one electromagnet is deactivated, the pinion housing is released from the track housing and is allowed to fall downwards such that the wedge-shaped rack member will force the two pinion members towards each other and cause the respective wheel member to bear against opposite sides of the guide wire rope and thus fixing the locking device against the guide wire rope.

11. The cage system of claim 1, wherein a guide wire rope extends from a module and the fish cage is movably connected to the guide wire rope such that it may move up and down in the water, controlled by buoyancy or other forces.

12. The cage system of claim 11, wherein the guide wire rope extends below the cage and comprises a stopper for supporting a bottom region of the cage.

13. The cage system of claim 11, wherein the guide wire rope is tethered to the seabed.

14. The cage system of claim 11, further comprising a valve assembly arranged at the bottom of the cage, and the valve assembly comprises a lower foundation having a support portion, and an axial member extending upwards from the lower foundation and connecting to a stopper member wherein when the valve assembly is in a lower-closed position a lower cage opening is abutting against the flange portion, and when the cage is lifted the cage opening is moved upwards until it abuts against the stopper member.

15. The cage system of any claim 11, wherein the lower foundation comprises a collector device, configured for collecting and containing dead fish and waste from the cage.

16. The cage system of claim 15, wherein the collector device comprises means for producing hypochloric acid and/or means for evacuating dead fish into a submergible container.

17. A method of rearing fish in a cage submerged in a body of water, comprising:
arranging and operating one or more light sources in the cage to emit light to attract zooplankton and/or fish into the cage and/or to simulate daylight.

18. The method of claim 17, further comprising:
enclosing one or more fish in the cage;
submerging the cage to a desirable depth in the body of water; and
operating said one or more light sources to emit light to attract zooplankton and/or fish into the cage and/or to simulate daylight.

19. The method of claim 17, wherein the cage is arranged in the body of water by a primary cable which extends from the cage and substantially to the surface, and the primary cable is fastened to a suitable foundation.

20. The method of claim 17, wherein the cage is part of the cage system as defined by claim 1.

21. Use of the cage system as defined by claim 1, for rearing fish inside the cage system without supplying man-made feed to the cage system.
